(19) United States
(12) Patent Application Publication
(10) Pub. No.: US 2009/0127181 A1
(43) Pub. Date: May 21, 2009

(54) METHOD AND APPARATUS FOR WATER RESTORATION

(76) Inventor: Udo Staschik, Winnipeg (CA)

Correspondence Address: STANDLEY LAW GROUP LLP, 6300 Riverside Drive, Dublin, OH, 43017, US

(21) Appl. No.: 11/940,950

(22) Filed: Nov. 15, 2007

(51) Int. Cl. B01D 24/00; G01N 1/10

(52) U.S. Cl. 210/284; 73/61.59

(57) ABSTRACT

A treatment tank for treating waste water or other liquid is provided. The treatment tank has an interior cavity of the treatment tank, a liquid introduction system for introducing a liquid to be treated, into a top end of the treatment tank, an exit aperture for removing liquid from a bottom end of the treatment tank and a plurality of removable layers of filter media. The removable layers of filter media are spaced substantially vertically in the treatment tank between the top end of the treatment tank and the bottom end of the treatment tank. Each layer of filter media has a permeable sheet adjacent a bottom surface of the layer of filter media, the permeable sheet allowing liquid to pass through the permeable sheet but preventing filter media in the layer of filter media from passing through the permeable sheet.

This invention is in the field of water treatment methods and apparatuses and more particularly to a method and apparatus for treating water by passing it through filter media.

### BACKGROUND

It is common to treat water by passing it through a treatment tank containing filter media. The water to be treated is introduced into a top of the treatment tank, typically using a number of spray nozzles which spray the water onto a top surface of the filter media. From the top surface, the water percolates down through the treatment media. As the water percolates down through the filter media, the quality of the water is improved by the filter media. At a bottom end of the treatment tank, the treated water exits the filter media.

The type of materials used as the filter media in these treatment tanks can vary greatly, including biodegradable, natural and/or manmade media. In some cases sand or soil can serve as a filter media and will remove some contaminants from the water passing through it. In other cases, manmade materials are used for the filter media. Often the filter media operates to remove contaminants from the water passing through the filter media by allowing air to reach the water, causing an aerobic reaction that is micro-biological and removes contaminants from the water. However, not all filter media work solely based on aerobic reaction and how a type of filter media removes contaminants from water can vary as greatly as the types of filter media available.

Different types of water to be treated, i.e. waste water, effluent, soiled water, grey water, storm water, etc., can require different types of filter media. For example, grey water may require one type of filter media to improve the quality of the water whereas effluent may require completely different filter media to adequately treat the effluent or even require a number of different layers containing different types of filter media to remove various different contaminants in the effluent.

If a single type of filter media is used, typically, the homogenous filter media simply forms a single layer contained in the treatment tank. When more than one type of filter media is used the different filter media can be placed in different layers in the tank or blended together. In these previous systems, the different types of filter media are usually piled into the treatment tank up to the desired level, typically making rough layers.

With these previous treatment tank arrangements, once the filter media is determined and installed in the treatment tank, it is often very difficult to change or alter because the filter media in the tank must all be removed and replaced to make the necessary changes. Additionally, once a particular filter media or even a number of layers of different filter media are chosen to be placed in a treatment tank, the treatment tank typically remains with that type or types of filter media because it is usually a laborious and time intensive task to remove all of the filter media and replace it with different filter media to change the filtering properties of the treatment tank. Even if the filter media is piled into the treatment tank with different types of filter media piled into the tank at different times forming rough layers, these layers can mix or blend together and it is very difficult if not impossible to separate the different types of filter media once they have been piled together in the treatment tank. Once the filter media is placed in these previous treatment tanks, it is often difficult to different portions of the filter media without dealing with the filter media as a whole.

A problem that occurs with the filter media is compaction; especially in the bottom layers of the filter media. For example, evaluations of the Waterloo Biofilters™ have shown that approximately 5% of the treatment media has to be replenished per year to compensate for the compression loss and subsequent loss of treatment capabilities. Even though various mechanical flow control components are typically used in these treatment tanks to control hydraulic loading on the filter media (e.g. valves and spray nozzles to spray the water being treated onto the top surface of the filter media), hydraulic loading of the filter media in the treatment tank by the water percolating through the filter media still causes stress on the filter media, tending to compact the filter media, especially the lower layers of the filter media. These hydraulic stresses can lead to significant and irreversible compaction of the bottom layer of the filter media, which renders the filter media less efficient at treating the water.

The compaction of the filter media is further augmented by the formation of a grease cap on the top of the filter media, which commonly occurs with certain types of waste water or other contaminated water. This grease cap is a layer of fat that tends to separate out of the water being treated and onto the top surface of the filter media. The grease cap can impede the flow of the water into the filter media and adds further weight to the top of the filter media serving to further compact the filter media.

In addition to hydraulic stresses caused by the water being treated compacting the filter media, treatment tanks that are subject to vibration or movement (such as being transported) can increase the amount of compaction of the filter media. The vibration or movement of the filter media can decrease the voids between the filter media reducing the effectiveness of the filter media.

### SUMMARY OF THE INVENTION

It is an object of the present invention to provide a method and apparatus that overcomes problems in the prior art.

In an aspect, a treatment tank is provided. The treatment tank comprises: at least one wall defining an interior cavity of the treatment tank; a liquid introduction system for introducing a liquid to be treated, into a top end of the treatment tank; an exit aperture for removing liquid from a bottom end of the treatment tank; and a plurality of layers of filter media. The layers of filter media are spaced substantially vertically in the treatment tank between the top end of the treatment tank and the bottom end of the treatment tank. Each layer of filter media has a permeable sheet adjacent a bottom surface of the layer of filter media, the permeable sheet allowing liquid to pass through the permeable sheet but preventing filter media in the layer of filter media from passing through the permeable sheet.

In a further aspect, each layer of filter media is contained in a removable tray and the permeable sheet forms a floor of the tray.

In another further aspect, the permeable sheet positioned adjacent the bottom surface of the layers of filter media encloses the layers of filter media.

In another aspect, a method for customizing a treatment tank is provided. The method comprising: providing a treatment tank. The treatment tank has: at least one wall defining an interior cavity of the treatment tank; a liquid introduction system for introducing a liquid to be treated, into a top end of the treatment tank; an exit aperture for removing liquid from a bottom end of the treatment tank; and a plurality of trays, the plurality of trays spaced between the top end of the treatment tank and the bottom end of the treatment tank, each tray having a permeable sheet forming a floor of the tray, the permeable sheet allowing liquid to pass through the permeable sheet but preventing filter media from passing through the permeable sheet. Next, the method comprises: obtaining a sample of liquid to be treated; testing the sample of water to determine contaminants in the liquid; determining a filter profile, the filter profile made up types of filter media that can treat at least one of the determined contaminants; and for each tray, placing a determined type of filter media from the filter profile on the floor of the tray to create a layer of filter media contained by the tray.

In another aspect, a treatment tank is provided. The treatment tank comprises: walls defining an interior cavity of the treatment tank; a liquid introduction system for introducing a liquid to be treated, into a top end of the treatment tank; an exit aperture for removing liquid from a bottom end of the treatment tank; filter media positioned in the interior cavity and having a top surface; and a mat comprising fibrous material, placed on the top surface of the filter media.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of a treatment tank in an aspect;

FIG. 2 is front view of the treatment tank of FIG. 1 with a door open;

FIG. 3 is a flowchart of a method of configuring a treatment tank, such as the treatment tank in FIG. 1;

FIG. 4 is a front view of the treatment tank of FIG. 1, with the door removed and a mat consisting of fibrous material on the top surface of the first layer of filter media;

FIG. 5 is a front view of a treatment tank in a further aspect;

FIG. 6 is a perspective view of a treatment tank with an access door on a top end of the tank;

FIG. 7 is a top view of the treatment tank of FIG. 6;

FIG. 8 is a side sectional view of the treatment tank of FIG. 6;

FIG. 9 is a side-sectional view of the treatment tank of FIG. 6 in another aspect; and

FIG. 10 is schematic illustration of a treatment tank in another aspect.

### DETAILED DESCRIPTION OF THE ILLUSTRATED EMBODIMENTS

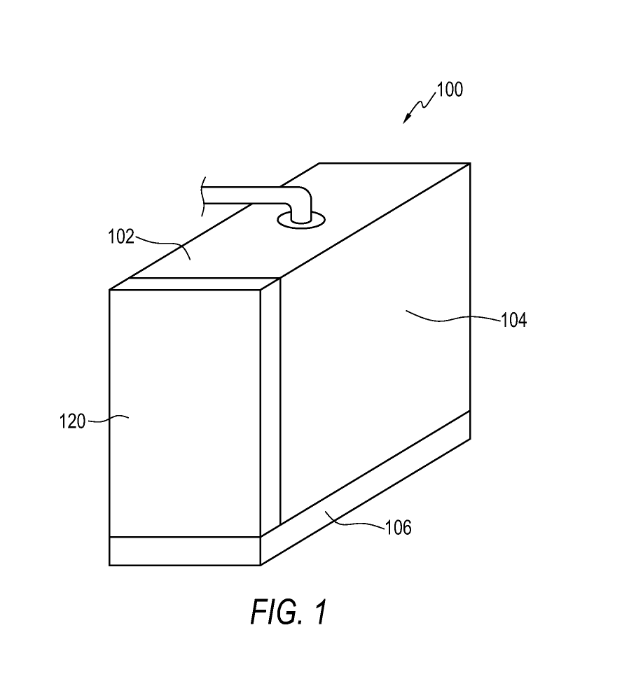

FIG. 1 illustrates an above ground treatment tank 100 containing a top 102, walls 104 and a bottom 106. A door 120 is provided to allow access to the interior cavity defined by the treatment tank 100.

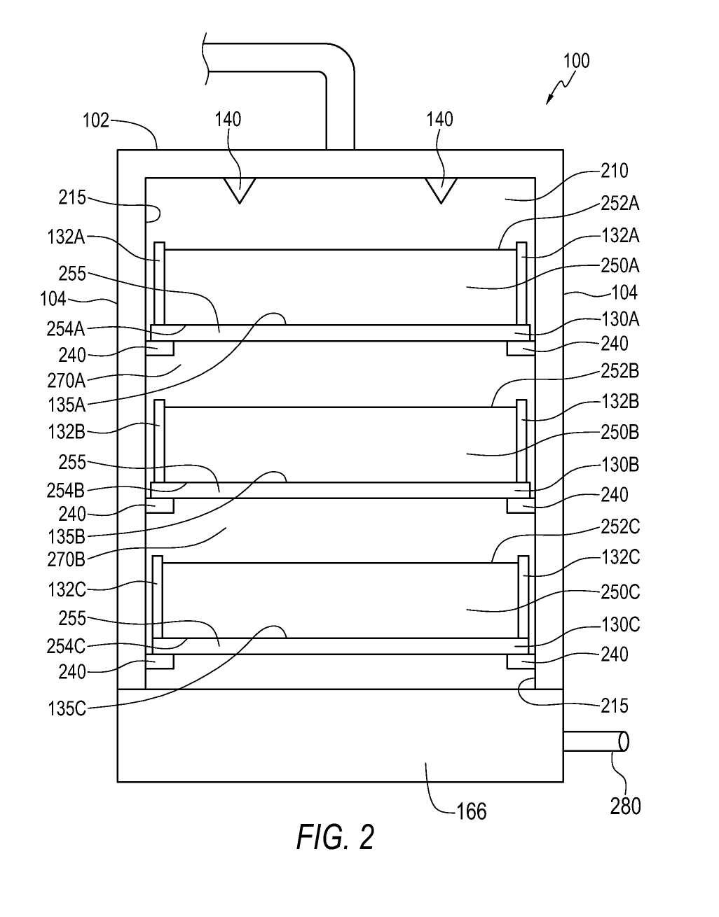

FIG. 2 illustrates the treatment tank 100 of FIG. 1 with the door 120 removed showing an interior cavity 210 of the treatment tank 100 defined by the walls 104. A liquid introduction system 140, nozzles are illustrated in FIG. 2, is provided at the top 102 of the treatment tank 100 for introducing the liquid or water to be treated into the interior of the treatment tank 100 and onto a top surface 252A of a top layer of filter media 250A. A number of layers of filter media 250A, 250B and 250C are provided in the interior cavity 210 of the treatment tank 100. Each layer of filter media 250A, 250B and 250C is contained by a tray 130A, 130B and 130C. Each tray 130A, 130B and 130C is guided and held in place by a set of rails 240 positioned along an interior surface 215 of the interior cavity 210 of the treatment tank 100. Each tray 130A, 130B and 130C has a rigid permeable sheet 255 that forms the floor 135A, 135B and 135C of the tray 130A, 130B and 130C, respectively. This permeable sheet 255 is suitable for supporting filter media placed on the permeable sheet 255. Typically, the trays 130A, 130B and 130C have side walls 132A, 132B and 133C extending upwards from the floor 135A, 135B and 135C to contain filter media placed in the trays 130A, 130B and 130C. The permeable sheets 255 forming the floors 135A, 135B and 135C of the trays 130A, 130B and 130C may be made permeable by providing a plurality of perforations in the permeable sheets 255, where the perforations are smaller than the filter media that will be placed on the permeable sheet 255, yet still large enough to allow the liquid or water being treated in the treatment tank 100 to pass through the permeable sheets 255 forming the floors 135A, 135B and 135C of the trays 130A, 130B and 130C, respectively. For filter media that is of a substantial size, such as Waterloo Biofilters™, the permeable sheets 255 forming the floors 135A, 135B and 135C of the trays 130A, 130B and 130C may be made of a material such as a relatively open weave of metallic wire or plastic that is still woven closely enough to prevent the Waterloo Biofilters™ from passing through the permeable sheets 255. In one aspect, the side walls 132A, 132B and 132C may also be permeable, to allow the liquid or water being treated to pass out of the trays 130A, 130B and 130C through the side walls 132A, 132B and 132C and/or to allow air to pass into the trays 130A, 130B and 130C.

Although three removable trays 130A, 130B and 130C are shown containing three layers of filter media 250A, 250B and 250C respectively, a person skilled in the art will appreciate that a different number of trays and filter media can be used. Additionally, a person skilled in the art will appreciate that the distance between the removable trays can be varied to allow different dwell times for the water or liquid passing through the different layers of filter media.

Permeable sheets 255 forming the floors 135A, 135B and 135C of the trays 130A, 130B and 130C, form air gaps 270A and 270B by supporting the layers of filter media 250A and 250B above lower layers of filter media 250B and 250C, respectively. A bottom surface 254A of the top layer of filter media 250A contained by the top tray 130A, is hydraulically separated from a top surface 252B of lower adjacent layer of filter media 250B by an air gap 270A. The bottom surface 254B of the second layer of filter media 250B is hydraulically separated by an air gap 270B from the top surface 253C of the lower adjacent layer of filter media 250. This provides air gaps 270A and 270B between the layers of filter media 250A, 250B and 250C, that allows air to circulate across the top surface 252B and 252C of the layers of filter media 250B and 250C.

In one aspect, air can be forced into the air gaps 270A and 270B.

In operation, water to be treated is introduced at the top 102 of the treatment tank 100 through the liquid introduction system 140. The liquid introduction system 140 disperses the water to be treated over a top surface 252A of the top layer of filter media 250A contained in the top tray 130A. In the top tray 130A, the water percolates through the top layer of filter media 250A contained in the top tray 130A until it reaches the permeable sheet 255 forming the floor 135A of the top tray 130A. The water then passes through the permeable sheet 255 forming the floor 135A of the tray 130A, passes through the air gap 270A, separating the permeable sheet 255 from the top surface 252A of the lower layer of filter media 250B contained in the next tray 130B and onto the top surface 252A of the lower layer of filter media 250B. The water then percolates through the layer of filter media 250B, through the bottom surface 254B of the layer of filter media 250B, through the permeable sheet 255 forming the floor 135B of the tray 130B and through the air gap 270 between the second layer of filter media 250B and the top surface 252C of the lower adjacent layer of filter media 250C. From the top surface 252C of the layer of filter media 250C, the liquid or water percolates through this layer of filter media 250C and through the permeable sheet 255 forming the floor 135C of the tray 130C.

In this manner, the water in the treatment tank 100 percolates through each layer of filter media 250A, 250B and 250C contained in each of the removable trays 130A, 130B until it reaches the bottom end 106 of the treatment tank 100, where it then passes out the treatment tank 100 through an exit aperture 280 located in the bottom end 106 of the treatment tank 100.

The treatment tank 100 can contain a single type of filter media. The different trays 130A, 130B and 130C in the treatment tank 100 can each contain the same type of filter media, with the height of each layer of filter media 250A, 250B and 250C in each of trays 130A, 130B and 130C, respectively, affecting the dwell time of the water or liquid percolating through the layers of filter media 250A, 250B and 250C in the treatment tank 100. In this manner, each of the different layers of filter media 250A, 250B and 250C contained by a removable tray 130A, 130B and 130C, respectively, can be removed and replaced as desired or needed separately and independently from the other trays 130A, 130B and 130C.

The trays 130A, 130B and 130C being removable allow the easy access and replacement of any of the layers of filter media 250A, 250B and 250C, independently from the other layers of filter media 250A, 250B and 250C. To access a layer of filter media 250A, 250B or 250C a person opens the door 120 to access the interior cavity 210 of the treatment tank 100, selects one of the removable trays 130A, 130B or 130C and removes the selected tray 130A, 130B or 130C. The trays 130A, 130B and 130C can be removed by sliding them along the rails 240 and out the open door 120 of the treatment tank 100.

If the trays 130A, 130B and 130C are relatively small, the person may be able to (either alone or with some help) manually remove the selected tray 130A, 130B and 130C from the treatment tank 100. For applications where the treatment tank 100 and trays 130A, 130B and 130C are relatively large, the person may need mechanical aid, such as a forklift, to lift and remove the selected tray 130A, 130B or 130C. With the selected tray 130A, 130B or 130C removed, the person can then remove the layer of filter media 250A, 250B or 250C currently contained in the tray 130A, 130B or 130C and replace it with new filter media. The person can remove and replace any or all of the trays 130A, 130B and 130C, individually, as necessary or desired and change the filter media in any of layers of filter media 250A, 250B and 250C contained in these trays 130A, 130B and 130C.

By having the trays 130A, 130B and 130C removable, this allows certain layers such as the top tray 130A and the bottom tray 130C to be removed and the layers of filter media 250A and 250C in these trays 130A and 130C to be replaced more often than the layer of filter media 250B in the middle tray 130B of the treatment tank 100, if needed. For example, if the liquid or water being treated contains fat or grease, a grease cap may form on the top surface 252A of the top layer of filter media 250A that can greatly reduce the amount of liquid or water that can pass through the grease cap and into the layer of filter media 250A and cause the layer of filter media 250A to compact. In this case, the top layer of filter media 250A will have to be replaced more frequently than the lower layers of filter media 250B and 250C.

The different removable trays 130A, 130B and 130 can also be used to hold different types of filter media so that each layer of filter media 250 does not necessarily contain the same type of filter media. Rather than using the same type of filter media in each of the different trays 130A, 130B and 130C, different types of filter media can be used in the different trays 130A, 130B and 130C. If the liquid or water to be treated has a number of contaminants that need a number of different types of filter media to treat or are better treated by using different types of filter media, the layers of filter media 250A, 250B and 250C can contain different types of filter media. For example, the first layer of filter media 250A may contain a different type of filter media than the second layer of filter media 250B. Additionally, the third layer of filter media 250C can contain a different type of filter media from the filter media in the second layer 250B and/or the first layer of filter media 250A.

By providing removable trays 130A, 130B and 130C that can be filled with different types of filter media, a generic treatment tank 100 can be supplied with the removable trays 130A, 130B and 130C empty, without any of filter media placed in the trays 130A, 130B and 130C and then customized for a particular application. Using the generic treatment tank 100 with the empty removable trays 130A, 130B and 130C, filter media can be chosen based on the contaminants in the liquid or water to be treated by the treatment tank 100 and placed in the trays 130A, 130B and 130C making layers of filter media 250A, 250B and 250C that have been customized with types of filter media chosen for the application.

Additionally, if the treatment tank 100 is found not be treating the liquid or water passing through it sufficiently, the layers of filter media 250A, 250B and 250C can be individually removed from the treatment tank 100 and any of the layers of filter media 250A, 250B and 250C replaced with a different type of filter media. The water could be determined to be insufficiently treated for a number of reason (i.e. contaminants present in the water are not being removed to a sufficient degree, other contaminants have been found in the treated water, a new type of filter media has become available, or contaminants that were previously in the source water are no longer present).

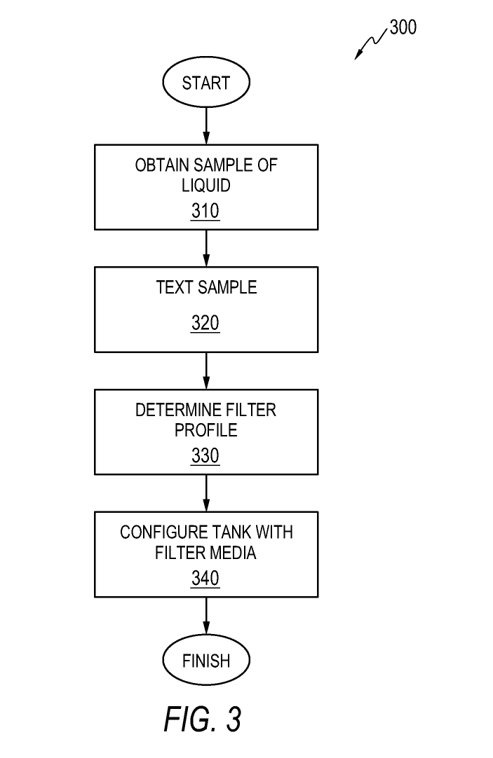

FIG. 3 illustrates a flowchart of a method 300 of configuring the treatment tank 100, as shown in FIG. 1, for a specific application. Method 300 begins and at step 310 a sample of the water or liquid to be treated is gathered. At step 320 the water is tested to determine contaminants present in the water. At step 330 a filter media profile is determined, the filter media profile comprising a listing of different filter media able to treat the determined contaminants and the amounts of the filter media necessary to treat each of the contaminants. At step 340 the treatment tank 100 is configured with the desired filter media, by placing the desired filter media in the different removable trays 130A, 130B and 130C to form layers of filter media 250A, 250B and 250C.

Referring to FIGS. 1-3, a generic treatment tank 100 can be provided with empty trays 130 and then customized using the method 300 by adding various filter media to form layers of filter media 250A, 250B and 250C particularly chosen for the specific application. This allows a single type of treatment tank 100 to be manufactured and then customized to treat a specific type of contaminated water for a specific application.

A common problem in treating certain types of water, such as waste water, is the creation of a grease cap on the top surface of the filter media, where the water to be treated is first sprayed over the top surface of the filter media. This grease cap forms from fat or grease contained in the water or liquid being treated the forms on top of the filter media. This grease cap can prevent the water being treated from flowing into through the top surface of the filter media and into the filter media in the treatment tank. Referring to FIG. 1, to address the build up of a grease cap on the top surface 252A of the layer of filter media 250A, the top tray 130A in the treatment tank 100 can be replaced more often than the layers of filter media 250B and 250C contained in the other trays 130B and 130C. In one aspect, the layer of filter media 250A in the top tray 130 can consists of a fibrous material. The fat or grease from the water being treated tends to collect in fibrous material and this first layer of filter media 250A consisting of fibrous material replaced more often when the grease cap starts to form.

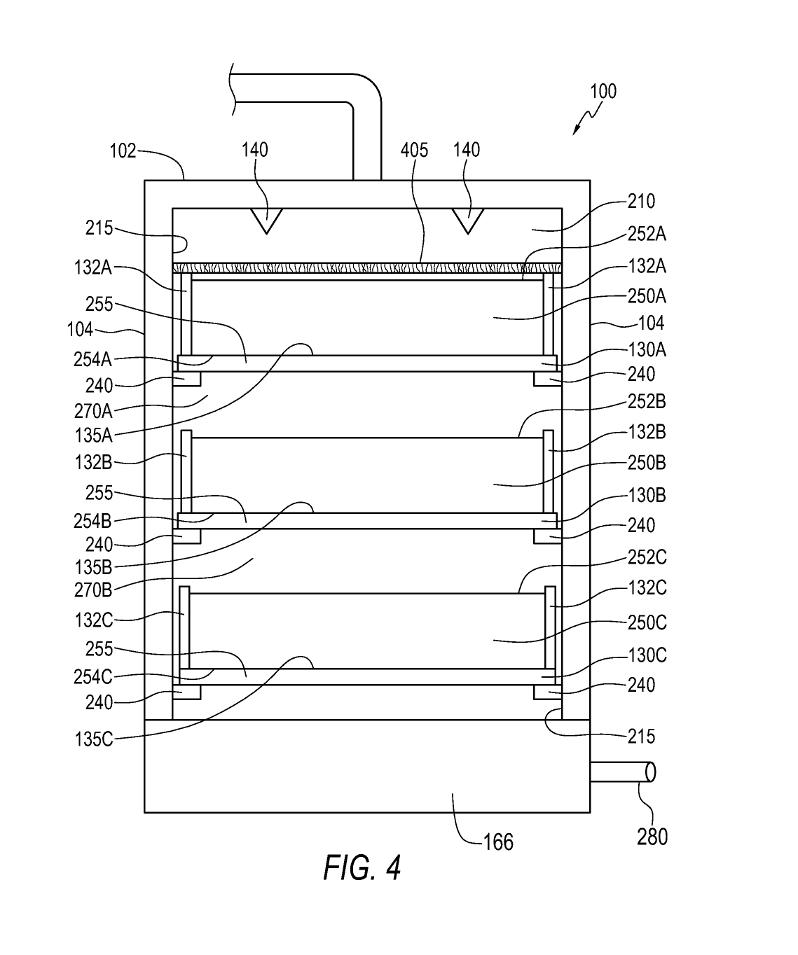

FIG. 4 illustrates a further aspect of the treatment tank 100, first shown in FIG. 1. A mat 405 consisting of fibrous material is placed on the top surface 252A of the first layer of filter media 250A. Fat or grease in the water or liquid being treated tends to collect in this mat 405 rather than in the layers of filter media 250A, 250B and 250C (especially the first layer of filter media 250A). The mat 405 with the collected fat or grease can then be more frequently removed from the treatment tank 100 than the layers of filter media 250A, 250B and 250C by opening the door 120 and removing the mat 405 from the top surface 252A of the first layer of filter media 250A.

The thickness and density of the mat 405 used can be varied depending on the amount of fat or grease that the water or liquid being treated is expected to contain. In some embodiments where the treatment tank 100 is very narrow, the mat 405 might be higher than it is wide.

It has been found that by providing a mat 405 of fibrous material for the top surface 252A of the first layer of filter media 250A, either alone in the top tray 130A or by covering the first layer of filter media 250A in the top tray 130A, grease from the water being treated, rather than clogging up layers of filter media 250B and 250C collects in sufficient amounts in the fibrous material making up the mat 405 which can then be replaced more frequently than the layers of filter material 250A, 250B and 250C.

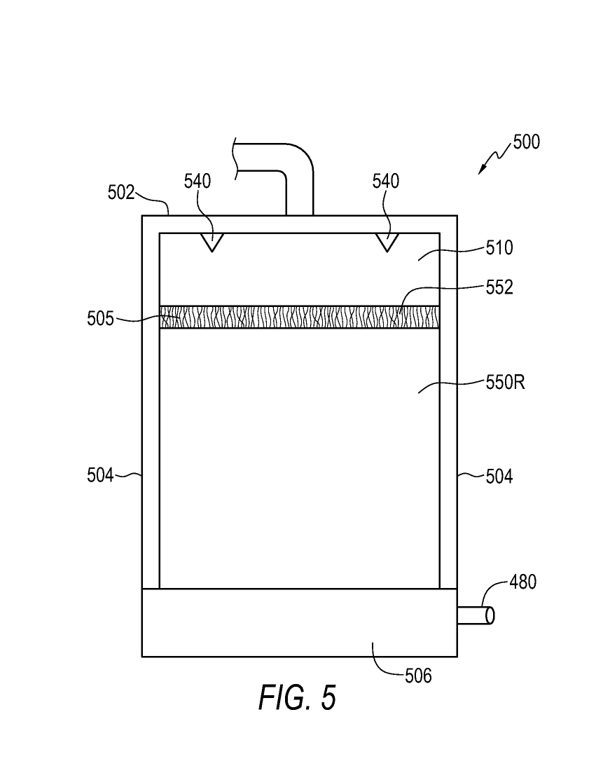

FIG. 5 illustrates a front view of a treatment tank 500 with a door (not shown) removed in a further aspect. The treatment tank 500 has walls 504 that define an interior cavity 510. Treatment tank 500 has filter media 550 placed in the interior cavity 510 between a top end 502 and a bottom end 506 of the treatment tank 500. A mat 505 made up of fibrous material is positioned on a top surface 552 of the filter media 550. A liquid introduction system 540 is provided near the top end 502 of the treatment tank 500 and an exit aperture 480 for removing liquid from the treatment tank is provided near a bottom end 506 of the treatment tank 500.

When a liquid or water is treated that contains fat or grease, this fat or grease will tend to collect in the mat 505 made up of fibrous material. The mat 505 can be replaced more frequently than the filter media 550 as the mat 505 begins to fill with the fat or grease. The thickness and density of the mat 550 used can be varied depending on the amount of fat or grease that the water or liquid being treated is expected to contain.

Referring again to FIG. 1, relatively large treatment tanks 100 for treating a relatively large amount of water are often overseen and maintained by specialized crews or operators and in these cases it is often sufficient to provide an access door 120 in a wall 104 of the treatment tank 100 to allow an operator access to the interior of the treatment tank 100. However, the access door 120 must be accessible and therefore the treatment tank 100 must be above ground and the seals on the access door 120 must be regularly checked to ensure that leaking is not occurring. It is not desirable to have water or liquid being treated to leak out of the treatment tank 100 through faulty or worn out seals on the access door 120. While providing an access door 120 for a treatment tank 100 might be perfectly suitable in some situations, in other conditions, such as where the amount of water to be treated is a smaller amount, lower maintenance is required and/or the treatment tank 100 is to be installed in a ground surface, having an access door 120 in a wall 104 of the treatment tank 100 may not be desirable.

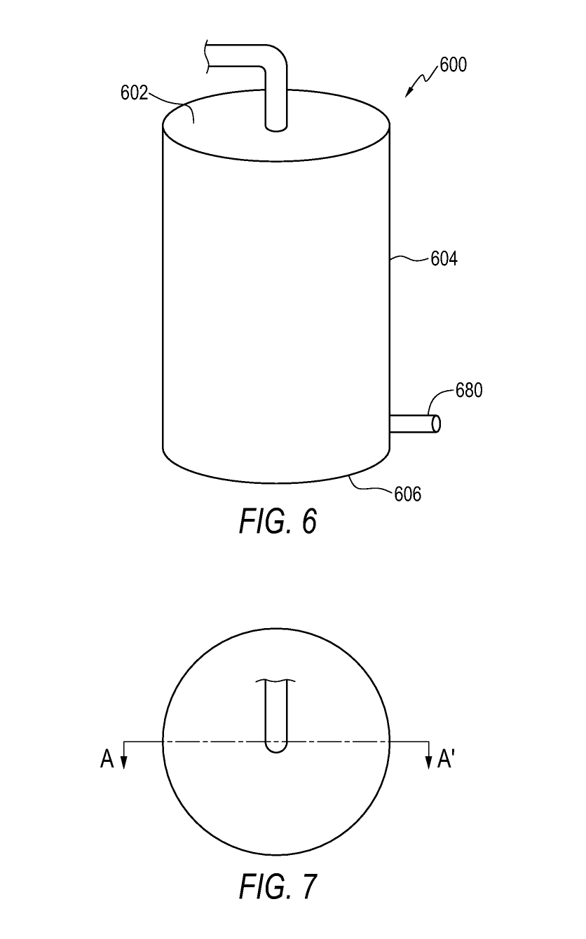

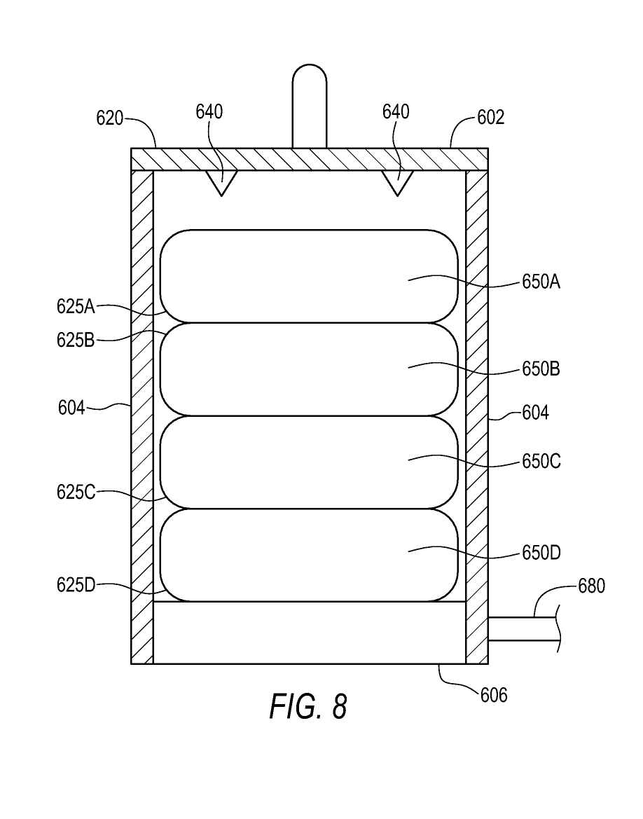

FIG. 6 illustrates a further embodiment of a treatment tank 600. FIG. 7 illustrates a top view of the treatment tank 600 and FIG. 8 illustrates a side sectional view of the treatment tank 600 along line AA′ shown in FIG. 6. Treatment tank 600 has an access door 620 in the top end 602 of the treatment tank 600. A liquid introduction system 640 is used to introduce a liquid or water into the treatment tank 600 to be treated. An exit aperture 680 is provided near a bottom end 606 of the treatment tank 600. Walls 604 define an interior cavity 610 of the treatment tank 600. A plurality of layers of filter media 650A, 650B, 650C and 650D are provided in the interior cavity 610. Each layer of filter media 650A, 650B, 650C and 650D has a permeable sheet 625A, 625B, 625C and 625D that completely enclosing it. These layers of filter media 650A, 650B, 650C and 650D enclosed in their respective permeable sheets 625A, 625B, 625C and 625D are stacked in the interior cavity 610 of the treatment tank 600. Each permeable sheet 625A, 625B, 625C and 625D allows the water or liquid being treated to pass through the permeable sheet 625A, 625B, 625C and 625D, but prevents the filter media enclosed by the permeable sheet 625A, 625B, 625C and 625D from passing out of the permeable sheet 625A, 625B, 625C and 625D.

In this manner, a person can select different types of filter media for each layer of filter media 650A, 650B, 650C and 650D to customize the treatment tank 600 to a particular application and each layer of filter media 650A, 650B, 650C and 650D is hydraulically separated from the others. When a person would like to replace one or more of the layers of filter media 650A, 650B, 650C or 650D (such as to change the type of filter media in or to replace it), the layers of filter media 650A, 650B, 650C and 650D can be removed through the access door 620 in the top end 602 of the treatment tank 600, until the layer of filter media 650A, 650B, 650C or 650D that the person wishes to replace is removed.

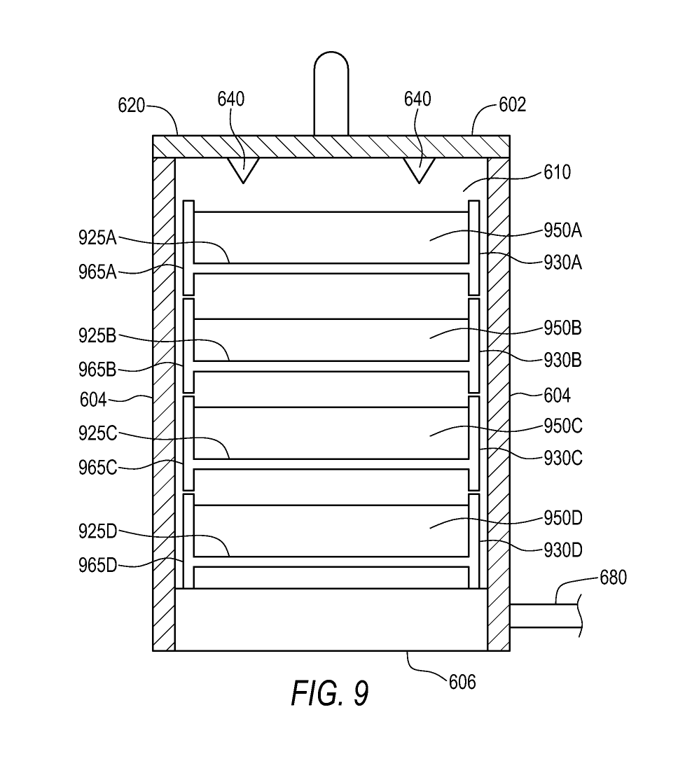

FIG. 9 is a side sectional view along line AA′ in FIG. 6 of the treatment tank 600 in another aspect. A plurality of layers of filter media 950A, 950B, 950C and 950D are provided in the interior cavity 610. Each layer of filter media 950A, 950B, 950C and 950D has a permeable sheet 925A, 925B, 925C and 925D adjacent to each bottom surface 954A, 954B, 954C and 954D of the layers of filter media 950A, 950B, 950C and 950D. The permeable sheets 925A, 925B, 925C and 925D support the layers of filter media 950A, 950B, 950C and 950D so that the layers of filter media 950A, 950B and 950C are separated from the lower layers of filter media 950B, 950C and 950D, respectively, by the permeable sheets 925A, 925B, 926C and 925D. Each permeable sheet 925A, 925B, 925C and 925D allows the water or liquid being treated to pass through the permeable sheet 925A, 925B, 925C and 925D, but prevents the filter media from passing through the permeable sheet 925A, 925B, 925C and 925D.

Each layer of filter media 950A, 950B, 950C and 950D is contained in a tray 930A, 930B, 930C and 930D where the permeable sheets 925A, 925B, 925C and 925D form the respective floors of the trays 930A, 930B, 930C and 930D. The trays 930A, 930B, 930C and 930D have frames 965A, 965B, 965C and 965D which support the permeable sheets 925A, 925B, 925C and 925D and the frames extend above and below the permeable sheets 925A, 926B, 926C and 925D allowing the trays 930A, 930B, 930C and 930D to be stacked on top of each other, spacing apart the layers of filter media 950A, 950B, 950C and 950D.

In this manner a person can select different types of filter media for each layer of filter media 950A, 950B, 950C and 950D to customize the treatment tank 600 to a particular application and each layer of filter media 950A, 950B, 950C and 950D is hydraulically separated from the others. When a person would like to replace one or more of the layers of filter media 950A, 950B, 950C or 950D (such as to change the type of filter media in or to replace it), the layers of filter media 950A, 950B, 950C and 950D can be removed through the access door 920 in the top end 902 of the treatment tank 900, until the layer of filter media 950A, 950B, 950C or 950D that the person wishes to replace is removed.

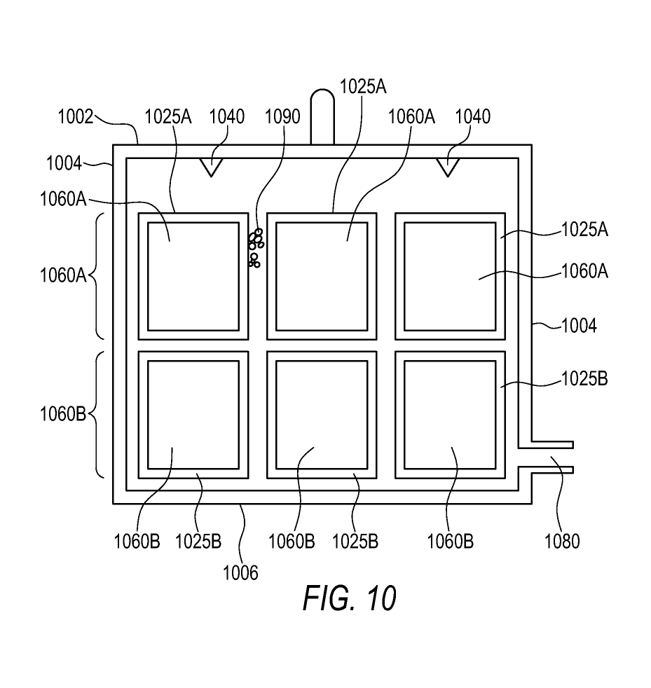

In cases where a treatment tank has relatively large dimensions (such as a relatively large width and/or depth), having the layer of filter media cover the entire cross-sectional area of a relative large treatment tank and removable as a single piece might make the layer of filter media too heavy and/or unwieldy to be easily or practically handled when the layer of filter is added or removed from the treatment tank (this is especially true if machinery such as forklifts, etc. are not available). FIG. 10 is schematic illustration of a treatment tank 1000 in another aspect where a top layer of filter media 1050A is divided into a number of separate top portions 1060A and a bottom layer of filter media 1050B is divided into a number of separate bottom portions 1060B.

Treatment tank 1000 has walls 1004 defining an interior cavity 1010. A liquid introduction system 1040 is provided near a top end 1002 of the treatment tank 1000 to introduce water or other liquid into the treatment tank 1000 to be treated. An exit aperture 1080 is provided near a bottom end 1006 of the treatment tank 1000 to for treated liquid or water to pass out of the treatment tank 1000.

A top layer of filter media 1050A and a bottom layer of filter media 1050B are provided in the interior cavity 1010. The top layer of filter media 1050A is divided into a number of top portions 1060A where each top portion 1060A is enclosed in a permeable sheet 1025A. The bottom layer of filter media 1050B is divided into a number of bottom portions 1060B where each bottom portion 1060B is enclosed in a permeable sheet 1025B. Each permeable sheet 1025A and 1025B allows water or other liquid being treated to pass through the permeable sheet 1025A and 1025B, but prevents the filter media enclosed by the permeable sheet 1025A and 1025B from passing out of the permeable sheet 1025A and 1025B. The permeable sheets 1025A separate the different top portions 1060A from each other and the permeable sheets 1025B separate the different top portions 1060B from each other while still allowing a liquid to pass between them. Additionally the permeable sheets 1025A and permeable sheets 1025B separate the top portions 1060A making up the top layer of filter media 1050A from the bottom portions 1060B making up the bottom layer of filter media 1050B.

In FIG. 10 each top portion 1060A of filter media 1050A is shown positioned directly above a lower portion 1060B of the bottom layer of filter media 1050B, however, each top portion 1060A could be staggered over the lower portions 1060B so that a top portion 1060A partially overlaps two or more lower portions 1060B.

In an aspect, the permeable sheets 1025A and 1025B are a flexible shape retaining weave (such as metal wire, plastic or fibrous material) that can be bent into shape to contain the top layers of filter media 1050A and bottom layers of filter media 1050B in a desired shape. Top portions 1060A and bottom portions 1060B can be made of any practical shape, such as square, rectangular or cylindrical. In the case where there are spaces between the top portions 1060A and/or the bottom portions 1060B (such as where they are shaped as cylinders), loose filter media 1090 can be placed in the gaps between the top portions 1060A and the gaps between the bottom portions 1060B in order to fill these gaps and try to prevent liquid from percolating unevenly through the treatment tank 1000.

In operation, liquid or water introduced into the treatment tank 1000 through the liquid introduction system 140 is introduced onto a top surface 1052A of the top layer of filter media 1050A. The liquid or water then percolates through the top layer of filter media 1050A and then through the bottom layer of filter media 1050B where it will be removed form the treatment tank 1000 through the exit aperture 1080 located near the bottom end 1006 of the treatment tank 1000.

In this manner, treatment tank 1000 with a relative large cross-sectional area can use a number of separate bottom portions 1060B each containing filter media that together from the bottom layer of filter media 1050A and a number of separate top portions 1060A each containing filter media that together from a top layers of filter media 1050A. Each of these top portions 1060A and bottom portions 1060B can be handled and removed from the treatment tank 1000 separately from the other top portions 1060A and/or bottom portions 1060B, making the addition and removal of a layer of filter media much easier to deal with than if the bottom layer of filter media 1050B and top layer of filter media 1050A had to be added or removed from the treatment tank 1000 as a single piece.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A treatment tank comprising:
at least one wall defining an interior cavity of the treatment tank;
a liquid introduction system for introducing a liquid to be treated, into a top end of the treatment tank;
an exit aperture for removing liquid from a bottom end of the treatment tank; and
a plurality of layers of filter media, the layers of filter media spaced substantially vertically in the treatment tank between the top end of the treatment tank and the bottom end of the treatment tank, each layer of filter media having a permeable sheet adjacent a bottom surface of the layer of filter media, the permeable sheet allowing liquid to pass through the permeable sheet but preventing filter media in the layer of filter media from passing through the permeable sheet.

2. The treatment tank of claim 1 wherein each layer of filter media is contained in a removable tray and the permeable sheet forms a floor of the tray.

3. The treatment tank of claim 2 wherein each tray comprises sides extending upwards from the floor and operative to contain the layer of filter media in the tray.

4. The treatment tank of claim 2 wherein each layer of filter media is supported by the permeable sheet adjacent to the bottom layer of filter media.

5. The treatment tank of claim 4 wherein for at least one of the layers of filter media an air gap separates the permeable sheet positioned adjacent to the bottom surface of the layer of filter media from the top surface of a lower adjacent layer of filter media.

6. The treatment tank of claim 5 wherein air is forcibly introduced into the air gap.

7. The treatment tank of claim 2 wherein the trays are spaced throughout an entire depth of the treatment tank.

8. The treatment tank of claim 2 wherein a door allows access to the interior cavity of the treatment tank, allowing an operator to access the trays.

9. The treatment tank of claim 8 wherein the door is positioned in the at least one wall of the treatment tank and the trays are removable by an operator opening the door to access the trays and removing the trays through the open door.

10. The treatment tank of claim 8 wherein the door is positioned at the top of the treatment tank.

11. The treatment tank of claim 10 wherein at least one tray comprises a frame supporting the permeable sheet, the frame extending above and below the permeable sheet supported by the frame and operative to rest on a top of a frame of a lower tray.

12. The treatment tank of claim 1 wherein for at least one of the layers of filter media, the permeable sheet positioned adjacent the bottom surface of the at least one of the layers of filter media encloses the at least one of the layers of filter media, the permeable sheet separating the at least one of the layers of filter media from at least one adjacent layer of filter media.

13. The treatment tank of claim 12 wherein a door allows access to the interior cavity of the treatment tank, allowing an operator to access the layers of filter media.

14. The treatment tank of claim 13 wherein the door is located at the top end of the treatment tank and the layers of filter media are accessed by an operator opening the door, accessing a top layer of filter media and removing the top layer of filter media.

15. The treatment tank of claim 1 wherein each layer of filter media contains the same type of filter media.

16. The treatment tank of claim 1 wherein more than one type of filter media is used in the layers of filter media.

17. The treatment tank of claim 1 wherein a top layer of filter media comprises fibrous material.

18. The treatment tank of 1 wherein a mat comprising fibrous material is on a top surface of a top layer of filter media.

19. The treatment tank of claim 1 wherein at least one of the layers of filter media comprises a plurality of horizontally spaced portions, each portion enclosed by a permeable sheet and containing filter media, each portion separately removable from the other portions in the at least one of the layers of filter media.

20. A method for customizing a treatment tank, the method comprising:
providing a treatment tank, the treatment tank comprising:
at least one wall defining an interior cavity of the treatment tank;
a liquid introduction system for introducing a liquid to be treated, into a top end of the treatment tank;
an exit aperture for removing liquid from a bottom end of the treatment tank; and
a plurality of trays, the plurality of trays spaced between the top end of the treatment tank and the bottom end of the treatment tank, each tray having a permeable sheet forming a floor of the tray, the permeable sheet allowing liquid to pass through the permeable sheet but preventing filter media from passing through the permeable sheet
obtaining a sample of liquid to be treated;
testing the sample of water to determine contaminants in the liquid;
determining a filter profile, the filter profile made up types of filter media that can treat at least one of the determined contaminants; and
for each tray, placing a determined type of filter media from the filter profile on the floor of the tray to create a layer of filter media contained by the tray.

21. A treatment tank comprising:
walls defining an interior cavity of the treatment tank;
a liquid introduction system for introducing a liquid to be treated, into a top end of the treatment tank;
an exit aperture for removing liquid from a bottom end of the treatment tank;
filter media positioned in the interior cavity and having a top surface; and
a mat comprising fibrous material, placed on the top surface of the filter media.
